(19) United States
(12) Patent Application Publication
(10) Pub. No.: US 2012/0089580 A1
(43) Pub. Date: Apr. 12, 2012

(54) UPDATE MANAGEMENT APPARATUS, UPDATE MANAGEMENT METHOD, AND COMPUTER-READABLE MEDIUM STORING UPDATE MANAGEMENT PROGRAM

(75) Inventors: Tomonori YAMASHITA, Kawasaki (JP); Tomohisa Suzuki, Kawasaki (JP)

(73) Assignee: FUJITSU LIMITED, Kawasaki-shi (JP)

(21) Appl. No.: 13/225,692

(22) Filed: Sep. 6, 2011

(30) Foreign Application Priority Data
Oct. 6, 2010 (JP) 2010-226510

(51) Int. Cl. G06F 17/30

(52) U.S. Cl. 707/695; 707/E17.005

(57) ABSTRACT

In an update management apparatus, a detection unit detects an update of one or more kinds of data included in a data set stored in a storage unit. A management unit generates a symbol sequence including a plurality of symbols corresponding to the respective plural kinds of data, and stores the symbol sequence as information indicating a version of the data set. The management unit modifies the symbol sequence indicating the previous version to change a symbol Q1 to Q2, which corresponds to the kind of data whose update has been detected, out of the plurality of symbols, to generate a new symbol sequence indicating the updated version.

### CROSS-REFERENCE TO RELATED APPLICATION

This application is based upon and claims the benefits of priority of the prior Japanese Patent Application No. 2010-226510, filed on Oct. 6, 2010, the entire contents of which are incorporated herein by reference.

### FIELD

The embodiments discussed herein are related to an update management apparatus, update management method, and computer-readable medium storing an update management program for managing data updates.

### BACKGROUND

In an information processing system, data stored in a storage device may be frequently updated as user's work progresses. To efficiently manage the update status of the data, a revision control system may be employed. Revision control is also called version control or version number control. A revision control system retains an update history including an update date and time of data and the details of updates, thereby allowing past data to be confirmed.

The revision control system may be employed for shared data to be updated by a plurality of users. For example, a project management system provided with a revision control function may be used in order for a plurality of people to share data on their project. There has been proposed a project management system which updates the version number of a file when the file is changed and registered, and stores differential information recording the contents of the change in association with the new version number.

There has been proposed a file management apparatus which manages a file in such a manner that, when the file is updated, the updated file is treated as a new base file if an amount of change to the file exceeds a predetermined reference limit, whereas the updated file is used as differential information if the amount of change does not exceed the predetermined reference limit. Please refer to Japanese Laid-open Patent Publications Nos. 2004-139588 (paragraph [0045]) and 6-187206 (paragraph [0012]).

By the way, in managing data, it may be desired that an update status is managed for each data set including plural kinds of data, not for each kind of data. For example, for the case of managing plural kinds of data, such as schedule data of a project and deliverable data created in the project, it may be desired to collectively manage the update statuses of these kinds of data regarding the project.

It needs to be considered how to manage the version of a data set including plural kinds of data. For example, one of methods is that a user gives a specific version number to a data set. This method, however, causes problems that workload is placed on the user and it is easy for the user to make mistakes in defining a version number. In addition, there is another method of giving a numerical number (for example, 1, 2, 3, . . . ) to a data set as its version number, and automatically incrementing the numerical number of the version number every time any data is updated in the data set. This method, however, causes a problem that it is difficult to recognize relations between plural kinds of data.

### SUMMARY

According to one embodiment, an update management apparatus for managing updates of a data set including plural kinds of data includes a detection unit that detects an update of one or more kinds of data of the data set stored in a storage unit, and a management unit that generates a symbol sequence including a plurality of symbols corresponding to the respective plural kinds of data, according to a detection result, and stores the generated symbol sequence in the storage unit as information indicating a version of the data set, wherein the management unit modifies a symbol sequence indicating a previous version to change symbols corresponding to kinds of data whose updates have been detected, out of the plurality of symbols, to generate the symbol sequence indicating an updated version.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an update management apparatus according to a first embodiment;

FIG. 2 illustrates a project management system according to a second embodiment;

FIG. 3 illustrates a hardware configuration of a project management apparatus;

FIG. 4 illustrates a functional block diagram of the project management apparatus;

FIG. 5 illustrates an example data structure of process data;

FIG. 6 illustrates an example data structure of task data;

FIG. 7 illustrates a specific example of deliverable data;

FIG. 8 illustrates an example data structure of a revision control table;

FIG. 9 illustrates an example data structure of an update log table;

FIG. 10 illustrates an example directory structure of a repository;

FIG. 11 illustrates an example data structure of a control table;

FIG. 12 is a flowchart of a backup process;

FIG. 13 is a flowchart of a backup data retrieval process; and

FIG. 14 illustrates an example revision number selection screen.

### DESCRIPTION OF EMBODIMENTS

Embodiments of the present invention will now be described with reference to the accompanying drawings, wherein like reference numerals refer to like elements throughout.

### First Embodiment

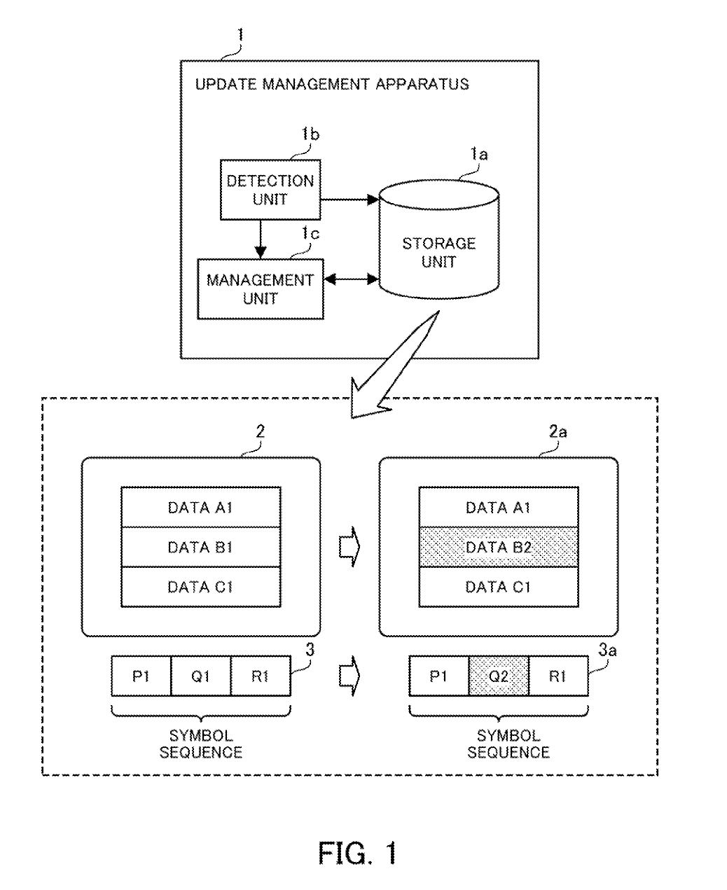

FIG. 1 illustrates an update management apparatus according to a first embodiment. The illustrated update management apparatus 1 is designed to manage updates of plural kinds of data. To this end, the update management apparatus 1 includes a storage unit 1a, a detection unit 1b, and a management unit 1c.

The storage unit 1a stores a data set 2 including plural kinds of data, for example, three kinds of data A1, B1, and C1 as illustrated in FIG. 1. In addition, the storage unit 1a stores a symbol sequence 3 indicating the version of the data set 2. This symbol sequence 3 includes a plurality of symbols corresponding to the respective plural kinds of data, for example, symbols P1, Q1, and R1 as illustrated in FIG. 1. Referring to FIG. 1, the symbols P1, Q1, and R1 correspond to the data A1, B1, and C1, respectively. Numerical numbers may be used instead of such symbols P1, Q1, and R1.

In this connection, the storage unit 1a may be an external storage device of the update management apparatus 1. For example, a database apparatus which is connected to the update management apparatus 1 over a network may be used as the storage unit 1a.

The detection unit 1b detects updates of one or more kinds of data in the data set 2a stored in the storage unit 1a. The detection unit 1b may detect an update after data is written in the storage unit 1a or before the data is written in the storage unit 1a (i.e., when a data write command is issued).

The management unit 1c generates a symbol sequence 3a including a plurality of symbols corresponding to the respective plural kinds of data, according to the detection result obtained by the detection unit 1b, and stores the generated symbol sequence in the storage unit 1a as information indicating the version of the data set 2a. In doing so, the management unit 1c modifies the symbol sequence 3 indicating the previous version to change symbols corresponding to kinds of data whose updates have been detected, out of the plurality of symbols, and takes the resultant as a symbol sequence 3a indicating the updated version. If updates of two or more kinds of data are detected, symbols corresponding to these kinds of data may be changed at the same time. In addition, symbols corresponding to kinds of data whose updates have not been detected out of the plurality of symbols are not changed.

Assume, for example, that the detection unit 1b checks the data set 2a and detects that data B1 of the data set 2 has been updated to data B2. In this case, the management unit 1c changes the symbol Q1 to Q2, which corresponds to the data B2 whose update has been detected, out of the symbols P1, Q1, and R1 in the symbol sequence 3, thereby generating the symbol sequence 3a. The symbols P1 and R1 corresponding to the data A1 and C1 whose updates have not been detected out of the symbols P1, Q1, and R1 are not changed. The new symbol sequence 3a includes symbols P1, Q2, and R1.

With such an update management apparatus 1, the detection unit 1b detects updates of one or more kinds of data in the data set 2 stored in the storage unit 1a. The management unit 1c generates a symbol sequence 3a including a plurality of symbols corresponding to the respective plural kinds of data according to the detection result, and stores the generated symbol sequence 3a in the storage unit la as information indicating the version of the data set 2a. In doing so, the management unit 1c modifies the symbol sequence 3 indicating the previous version to change symbols corresponding to the kinds of data whose updates have been detected, out of the plurality of symbols, thereby generating the symbol sequence 3a indicating the updated version.

The above technique offers simple version control of a data set including plural kinds of data. For example, it is possible to easily recognize to what extent the data included in the data set 2, 2a has been updated, by confirming the symbol sequence 3, 3a. For example, the symbol sequence 3a indicates that the data A1 and C1 out of the data A1, B1, and C1 was not updated, and the data B1 was updated to data B2 at a past time point. This makes it possible to easily review plural kinds of desired past data.

The detection unit 1b may be designed to calculate an index (an amount of change) for each kind of data, which indicates how much the data was changed. For example, a change in data size before and after an update or a change in the number of characters or lines before and after an update may be used. The management unit 1c, in turn, may be designed to generate the symbol sequence 3a if an amount of change calculated by the detection unit 1b is greater than a predetermined reference value, and not to generate the symbol sequence 3a otherwise. This makes it possible to change the version number of the data set 2 only when a large change is made.

A following second embodiment describes a case where the update management apparatus 1 is implemented in a project management system which supports management of a system development project. However, the update management apparatus 1 according to the first embodiment may be applied in an information processing system, like a file server, other than the project management system.

### Second Embodiment

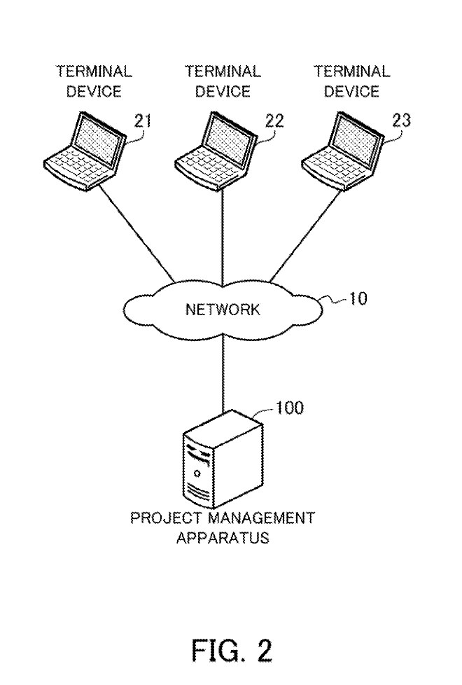

FIG. 2 illustrates a project management system according to the second embodiment. This project management system assists in management of a system development project. The illustrated project management system includes terminal devices 21 to 23 and a project management apparatus 100. These terminal devices 21 to 23 and project management apparatus 100 are connected to a network 10.

The terminal devices 21 to 23 are computers of the members of a project, such as system development engineers. Users of the terminal devices 21 to 23 generate and update data with the terminal devices 21 to 23.

The project management apparatus 100 is a server computer that assists in management of project progress. This project management apparatus 100 includes a repository for storing information on the project (project information). The project information is a data set including plural kinds of data, and in this example, includes the following three kinds of data.

(i) The first kind of data is process data, which indicates the processes of a project. The processes involve a plurality of work units (tasks). The process data includes records which indicate an order of execution of a plurality of tasks and the scheduled dates of the tasks, for example.

(ii) The second kind of data is task data, which describes details on each of the plurality of tasks included in the processes. The task data includes records which indicate the progress of each task.

(iii) The third kind of data is deliverable data, which is crated in the course of executing tasks. Some deliverable data may be created in the course of executing a task; some may be created when a task is completed. In addition, some deliverable data may be updated in the course of executing the same task or different tasks. For example, a task of “design” may involve creating planning data as deliverable data. As another example, a task of “estimate” may involve creating estimate data.

The users are able to view and update project information stored in the project management apparatus 100 by using the terminal devices 21 to 23. The project management apparatus 100 supports efficient project management by collectively managing project information.

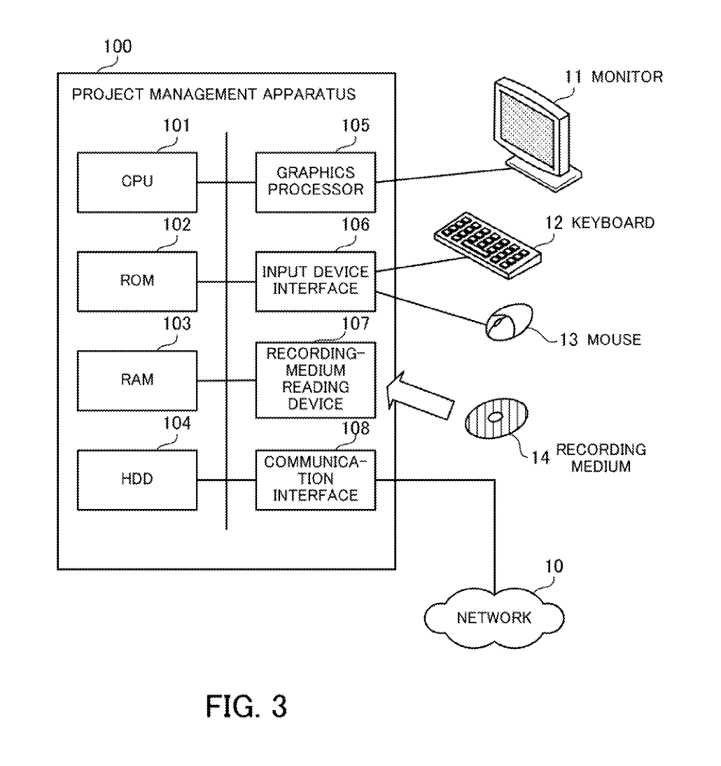

FIG. 3 illustrates a hardware configuration of a project management apparatus. The illustrated project management apparatus 100 includes a Central Processing Unit (CPU) 101, a Read Only Memory (ROM) 102, Random Access Memory (RAM) 103, a Hard Disk Drive (HDD) 104, a graphics processor 105, an input device interface 106, a recording-medium reading device 107, and a communication interface 108.

The CPU 101 controls the entire operation of the project management apparatus 100 by executing an Operating System (OS) program and application programs.

The ROM 102 stores predetermined programs such as Basic Input/Output System (BIOS) program to be executed on activation of the project management apparatus 100. The ROM 102 may be a rewritable non-volatile memory.

The RAM 103 temporarily stores at least part of the OS program and application programs to be executed by the CPU 101. The RAM 103 also temporarily stores data to be used for CPU processing.

The HDD 104 stores the OS program and application programs. The HDD 104 stores data to be used for CPU processing. Instead of the HDD 104 (or together with the HDD 104), other kinds of non-volatile memory devices such as Solid State Drive (SSD) may be used.

The graphics processor 105 is connected to a monitor 11, and is designed to display images on the monitor 11 under the control of the CPU 101.

The input device interface 106 is connected to input devices such as a keyboard 12 and mouse 13, and is designed to output signals received from the input devices to the CPU 101.

The recording-medium reading device 107 is a device that reads data from a recording medium 14. For example, a program to be executed by the project management apparatus 100 is recorded on the recording medium 14. By executing the project management program recorded on the recording medium 14, the project management apparatus 100 is able to realize a project management function, which will be described later. That is to say, a program describing the processing contents for the project management may be recorded on the computer-readable recording medium 14 which is then distributed.

As the recording medium 14, a magnetic recording device, an optical disc, a magneto-optical recording medium, or a semiconductor memory may be used. Magnetic recording devices include HDDs, Flexible disks (FD), and magnetic tapes. Optical discs include Compact Discs (CD), CD-R (Recordable)/RW (ReWritable), Digital Versatile Discs (DVD), and DVD-R/RW/RAM. Magneto-optical recording media include Magneto-Optical disks (MO). Semiconductor memories include flash memories such as Universal Serial Bus (USB) memories.

The communication interface 108 is connected to the network 10, and is designed to perform data communications with the terminal devices 21 to 23 over the network 10.

It is possible that the project management program is stored in another server computer (not illustrated) connected to the network 10. In this case, the project management apparatus 100 downloads and executes the program from the server computer. The terminal devices 21 to 23 may be realized with the same hardware configuration as the project management apparatus 100.

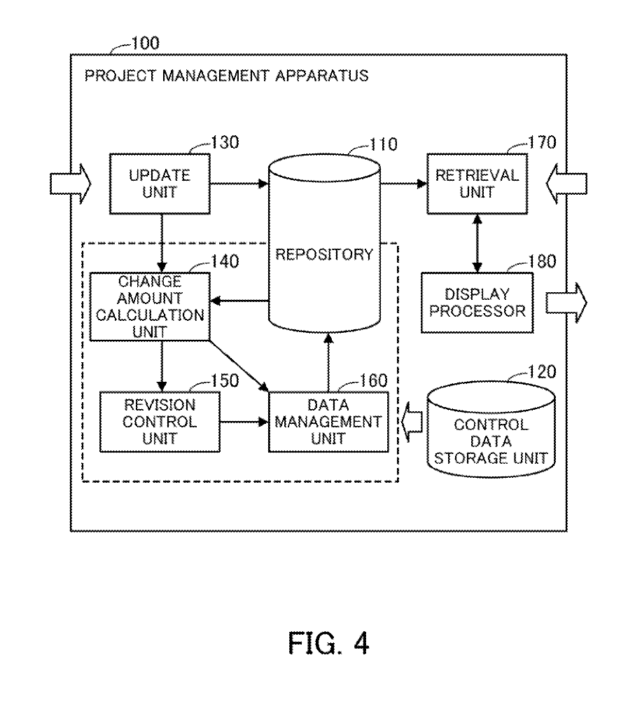

FIG. 4 is a functional block diagram of a project management apparatus. The illustrated project management apparatus 100 includes a repository 110, a control data storage unit 120, an update unit 130, a change amount calculation unit 140, a revision control unit 150, a data management unit 160, a retrieval unit 170, and a display processor 180. The functions of these units are realized on the project management apparatus 100 by the CPU 101 executing a project management program. All or part of these functions may be implemented by dedicated hardware components.

The repository 110 is a storage region (for example, a region saved in the RAM 103 or HDD 104) for storing project information. As described earlier, project information includes process data, task data, and deliverable data. The project information is updated to reflect project progress. The repository 110 manages backup data of project information of each version together with a revision number given thereto, in addition to the latest project information. A revision number is represented by a symbol sequence which indicates the version of the entire project information. The repository 110 stores a revision control table which lists revision numbers.

The control data storage unit 120 stores control data. The control data is used for controlling the operations of the change amount calculation unit 140, revision control unit 150, and data management unit 160.

The update unit 130 receives a check-in command from a terminal device 21 to 23, and updates the project information stored in the repository 110. The check-in operation is that the terminal device 21 to 23 requests the project management apparatus 100 to add new data or update existing data. When the user creates a check-in command for data created and edited on the terminal device 21 to 23, the terminal device 21 to 23 sends the check-in command to the project management apparatus 100. The update unit 130 updates the project information by adding data or overwriting data in the repository 110 according to the received check-in command. After updating the project information, the update unit 130 notifies the change amount calculation unit 140 of this update.

Upon receipt of the notification of the update of the project information from the update unit 130, the change amount calculation unit 140 confirms which kind of data out of three has been updated. In addition, the change amount calculation unit 140 compares the latest backup data and the updated data to calculate an amount of data change. Then, the change amount calculation unit 140 determines whether to change the revision number. If it is determined that the revision number is to be changed, the change amount calculation unit 140 informs the revision control unit 150 which kind of data has been updated, and also informs the data management unit 160 of the amount of data change.

When informed which kind of data has been updated from the change amount calculation unit 140, the revision control unit 150 consults the revision control table stored in the repository 110 to confirm the latest revision number. Then, the revision control unit 150 identifies symbols corresponding to the updated data in the latest revision number, and changes the identified symbols to thereby generate a new revision number. The revision control unit 150 then informs the data management unit 160 of the generated revision number.

The data management unit 160 produces a backup of the project information with a method appropriate for an amount of data change. More specifically, the data management unit 160 selects a full or partial backup depending on the amount of change detected by the change amount calculation unit 140, and produces backup data of updated project information. The data management unit 160 then stores the revision number received from the revision control unit 150 and the produced backup data in association with each other in the repository 110. At this time, the data management unit 160 updates the revision control table.

The retrieval unit 170 receives a checkout command from the terminal device 21 to 23, and retrieves project information from the repository 110. The checkout operation is that the terminal device 21 to 23 requests the project management apparatus 100 to retrieve the project information of latest or specified revision number. When the user operates the terminal device 21 to 23 for checkout, the terminal device 21 to 23 sends a checkout command to the project management apparatus 100. The retrieval unit 170 retrieves the project information of latest or specified revision number from the repository 110 according to the received command.

The display processor 180 provides the terminal device 21 to 23 with Graphical User Interface (GUI) for the user to make a checkout operation. For example, the display processor 180 acquires a list of revision numbers from the revision control table stored in the repository 110, and sends the terminal devices 21 to 23 data of a screen to be used for selection of a revision number. The user operates an input device while viewing an operation screen displayed on the monitor of the terminal device 21 to 23 in order to select a desired revision number of project information to be retrieved. In addition, the display processor 180 may provide a screen displaying data such as process data in response to a user's checkout operation.

In a checkout operation, the terminal device 21 to 23 is able to provide a user with data acquired from the project management apparatus 100. Then, the user is able to update the acquired data, and performs a check-in operation for the updated data.

The following describes backup data of process data, task data, and deliverable data. The repository 110 manages backup data for each kind of data. Each kind of backup data is given a revision identifier (ID) (which represents an order of production of backup data of the kind) identifying a revision to the kind of data, separately from a revision number identifying a revision to the entire project information.

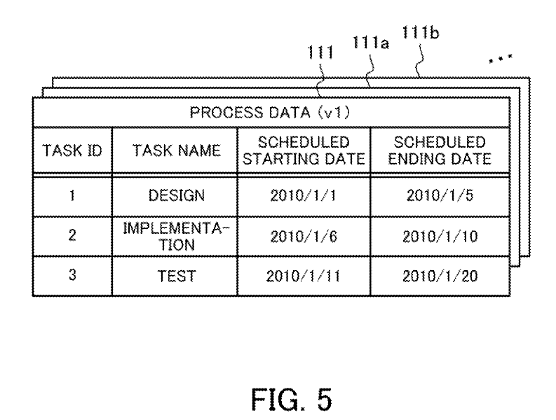

FIG. 5 illustrates an example data structure of process data. Process data 111, 111a, 111b, . . . are backup data of process data of respective revisions and are stored in the repository 110. The process data 111 is backup data of the oldest revision (revision ID=v1). The process data 111a is data of revision (v2) next to v1, and the process data 111b is data of revision (v3) next to v2. The following describes a data structure of process data 111 as an example, and the other process data 111a, 111b, . . . have the same data structure as the process data 111.

The process data 111 has fields for Task ID, Task Name, Scheduled Starting Date, and Scheduled Ending Date. Information in fields arranged in a horizontal direction is associated with each other to form one record of the process data. The Task ID field contains identification information identifying a task. The Task Name field contains the name of the task. The Scheduled Starting Date field contains a scheduled starting date of the task. The Scheduled Ending Date field contains a scheduled ending date of the task.

For example, the process data 111 has a record with a task ID of “1”, a task name of “design”, a scheduled starting date of “2010/1/1”, and a scheduled ending date of “2010/1/5”. This record means that a design process is a task that is executed first and that starts on Jan. 1, 2010 and ends on Jan. 5, 2010 according to the schedule.

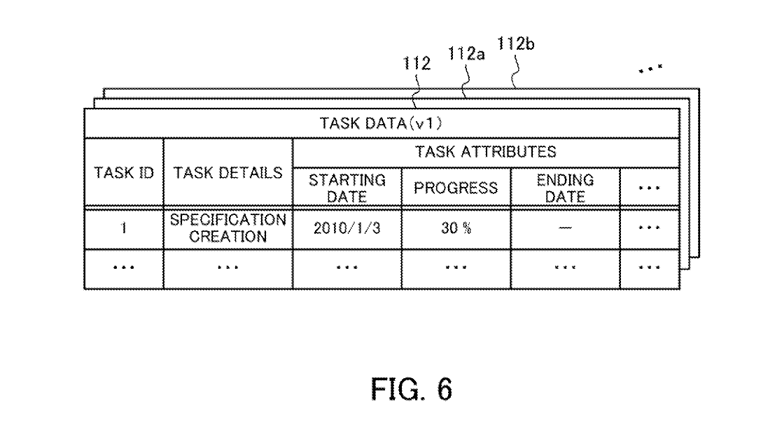

FIG. 6 illustrates an example data structure of task data. The task data 112, 112a, 112b, . . . are backup data of task data of respective revisions and are stored in the repository 110. The task data 112 is data of the oldest revision (revision ID=v1). The task data 112a is data of revision (v2) next to v1. The task data 112b is data of revision (v3) next to v2. The following describes a data structure of the task data 112 as an example, and the task data 112a, 112b, . . . , have the same data structure as the task data 112.

The task data 112 has fields for Task ID, Task Details, and Task Attributes. Information in fields arranged in a horizontal direction is associated with each other to indicate specific details on one task. The Task ID field contains identification information identifying a task. The Task details field contains text indicating specific task details of the task. The Task Attributes field contains information indicating the progress status of the task. The task attributes include an actual starting date of the task, a current progress percentage, and an actual ending date of the task.

For example, the task data 112 has a record with a task ID of “1”, task details of “specification creation”, a starting date of “2010/1/3”, a progress of “30%”, and an ending date of “- (no entry)”. This record means that the task details of the design process is “specification creation”, and this task started on Jan. 3, 2010, and the scheduled work unit has been completed by 30%.

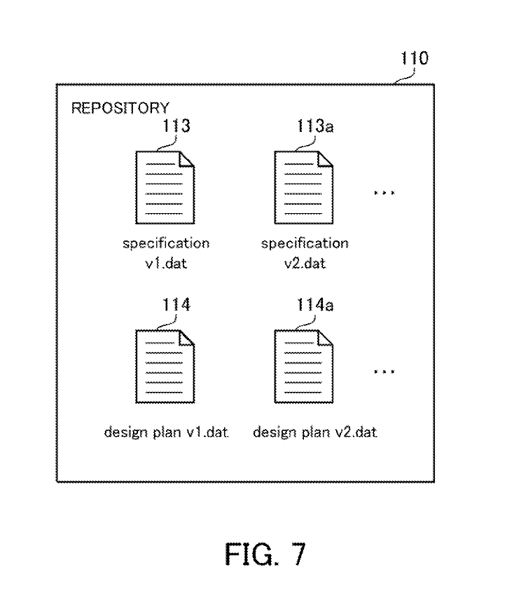

FIG. 7 illustrates a specific example of deliverable data. Deliverable data 113, 113a, 114, 114a, . . . are backup data of deliverable data (for example, document files) of respective revisions, and are stored in the repository 110. The deliverable data 113 and 114 is data of the oldest revision (revision ID=v1). The deliverable data 113a and 114a is data of revision (v2) next to v1.

The deliverable data 113 and 113a are specification files describing specifications. The deliverable data 113 and 113a have file names of “specification v1.dat” and “specification v2.dat”, respectively. The deliverable data 114 and 114a are design plan files describing the details of a design plan. The deliverable data 114 and 114a have file names of “design plan v1.dat” and “design plan v2.dat”, respectively.

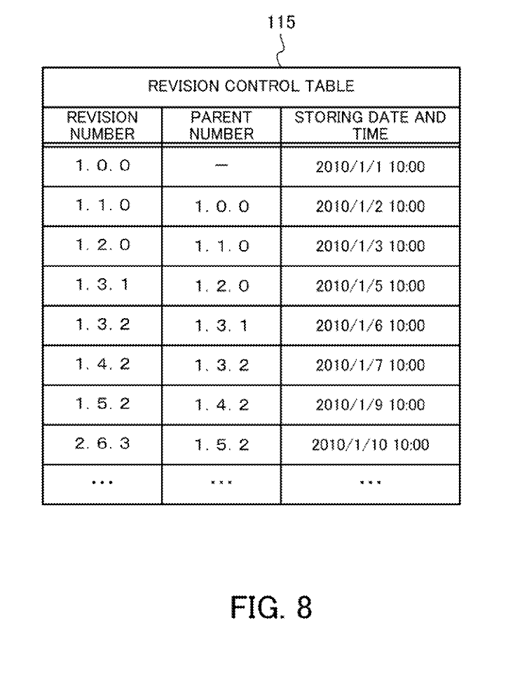

FIG. 8 illustrates an example data structure of a revision control table. The revision control table 115 is stored in the repository 110. The revision control table 115 has fields for Revision Number, Parent Number, and Storing Date and Time. Information in fields arranged in a horizontal direction is associated with each other to form information on one revision.

The Revision Number field contains a revision number indicating a revision of the entire project information. The Parent Number field contains a revision number given to a previous revision to the revision indicated in the Revision Number field. The Storing Date and Time field contains a date and time for when the new revision number was given and backup data was made.

A revision number has three digits, like “x.y.z” with “. (period)” as a separator for separating the digits. “x” is taken as the first digit, “y” is taken as the second digit, and “z” is taken as the third digit (that is to say, the first digit is the most significant digit, and the third digit is the least significant digit). The first digit (x) corresponds to the revision ID of process data, the second digit (y) corresponds to the revision ID of task data, and the third digit (z) corresponds to the revision ID of deliverable data.

For example, assume that the revision control table 115 has a record with a revision number of “1.0.0”, a parent number of “- (no entry)”, and a storing date and time of “2010/1/1 10:00”. This record means that project information was given the first revision number at 10:00 on Jan. 1, 2010. The record also means that the process data was registered in the repository 110 and that task data or deliverable data was not registered. In this connection, lower-order digits of “0” may be omitted in notation. For example, “1.0.0” may be expressed by “1”.

Further, assume that the revision control table 115 has a record with a revision number of “1.1.0”, a parent number of “1.0.0”, and a storing date and time of “2010/1/2 10:00”. This record means that the project information was given a revision number of “1.1.0” as a number next to “1.0.0” at 10:00 on Jan. 2, 2010. The record also means that the process data was not changed from the previous revision (or a little change), task data was registered in the repository 110, and deliverable data was not registered. In this connection, as described above, “1.0.0” may be expressed by “1.1”, omitting the lowest-order digit of “0”.

Still further, assume that the revision control table 115 has a record with a revision number of “1.2.0”, a parent number of “1.1.0”, and a storing date and time of “2010/1/3 10:00”. This record means that the project information was given a revision number of “1.2.0” as a revision number next to “1.1.0” at 10:00 on Jan. 3, 2010. The record also means that the process data was not changed from the previous revision (or a little change), the task data was updated after the previous revision, and deliverable data was not registered.

Still further, assume that the revision control table 115 has a record with a revision number of “1.3.1”, a parent number of “1.2.0”, and a storing date and time of “2010/1/5 10:00”. This record means that the project information was given a revision number of “1.3.1” as a revision number next to “1.2.0” at 10:00 on Jan. 5, 2010. The record also means that the process data was not changed from the previous revision (or a little change), the task data was updated after the previous revision, and deliverable data was registered in the repository 110.

In this connection, the format for revision numbers is not limited to the above format. For example, the value of each digit, (x, y, z), may be expressed in binary, octal, or hexadecimal form, instead of hexadecimal form. In addition, instead of a monotonic increase in the value of each digit, a monotonic decrease may be employed. Further, more than three digits may be prepared for dealing with more kinds of data. Sill further, a larger number of digits or a smaller number of digits may be specified by a project chief leader. The above format uses a separator symbol (for example, period) to separate digits. Alternatively, another method may be employed for identifying digits. For example, an upper limit number of digits may be previously determined to express a revision and grouped. For example, in the case where all revisions for each of three kinds of data are represented by a digit group with four digits (that is to say, an entire revision number is expressed in 12 digits), a format of “000100020003” may be employed, without using separator symbols.

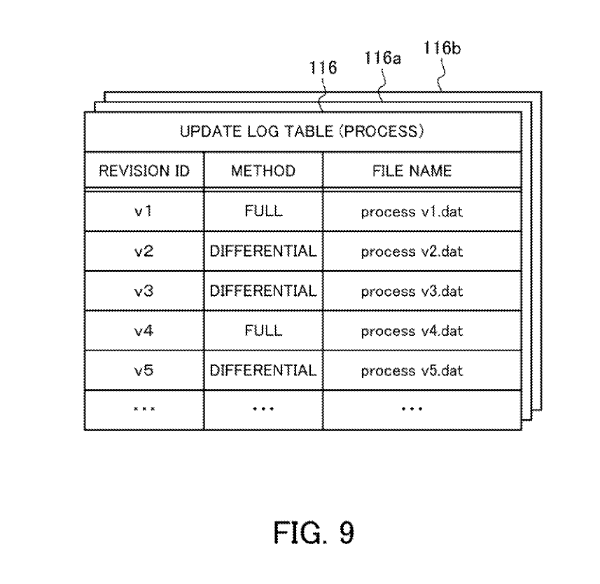

FIG. 9 is an example data structure of an update log table. Update log tables 116, 116a, and 116b are prepared by the data management unit 160 for the respective kinds of data, and are stored in the repository 110. The update log table 116 is a table for recording an update log for process data. The update log table 116a is a table for recording an update log for task data. The update log table 116b is a table for recording an update log for deliverable data. The following describes a data structure of the update log table 116 as an example, and the other update log tables 116a and 116b have the same data structure.

The update log table 116 has fields for Revision ID, Method, and File Name. Information in fields arranged in a horizontal direction is associated with each other to form information on one revision of process data. The Revision ID field contains an ID identifying a revision of process data. The Method field contains information (full or differential) indicating whether a backup is a full backup or a differential backup. The File Name field contains the file name of backup data.

For example, assume that the update log table 116 has a record with a revision ID of “v1”, a method of “full”, and a file name of “process v1.dat”. This record means that a full backup of the process data of revision “v1” is stored in the repository 110 as “process v1.dat”. In this connection, “v1” of the revision ID corresponds to “1” in the first digit of the revision number of the entire project information.

In addition, assume that the update log table 116 has a record with a revision ID of “v2”, a method of “differential”, and a file name of “process v2.dat”. This record means that a differential backup of the process data of revision “v2” is stored in the repository 110 as “process v2.dat”. In this connection, “v2” of the revision ID corresponds to “2” in the first digit of the revision number.

Differential backup data of the process data indicates differences from the process data of previous revision. That is, a file of “process v2.dat” records differences from the file of “process v1.dat”, which is backup data of previous revision (v1). On the other hand, in the full backup, process data is fully backed up. That is, a file of “process v1.dat” records the entire process data.

In this connection, it is possible to determine which backup to apply, a full backup or a differential backup, for each kind of data. For the case where some kinds of data are to be backed up simultaneously, it is possible to independently determine whether to perform a full backup or differential backup for process data, whether to perform a full backup or differential backup for task data, and whether to perform a full backup or differential backup for deliverable data. Then, a specified full backup or differential backup is performed for each kind of data.

In addition, depending on kinds of data, there are two cases considered. The first case is that data is collectively recorded in one file, and the second case is that data is recorded in a plurality of files separately. For example, it is considered that each of process data and task data is recorded in one file. On the other hand, deliverable data may be a collection of a plurality of files (for example, specification file and design plan file). In this connection, different backup methods may be applied for data of the first and second cases.

For example, with respect to data of the first case, one file is fully copied in the full backup, whereas differences in contents between files are calculated and data indicating the differences is generated in the differential backup. On the other hand, with respect to data of the second case, all files are fully copied in the full backup, whereas only updated files out of the plurality of files are copied in the differential backup. For example, assume that only a specification file is updated. In this case, the specification file and design plan file are both copied in the full backup, whereas only the updated specification file is copied in the differential backup. In this connection, similarly to the differential backup for data of the first case, differences in contents between files are calculated and data indicating the differences may be generated in the differential backup for data of the second case.

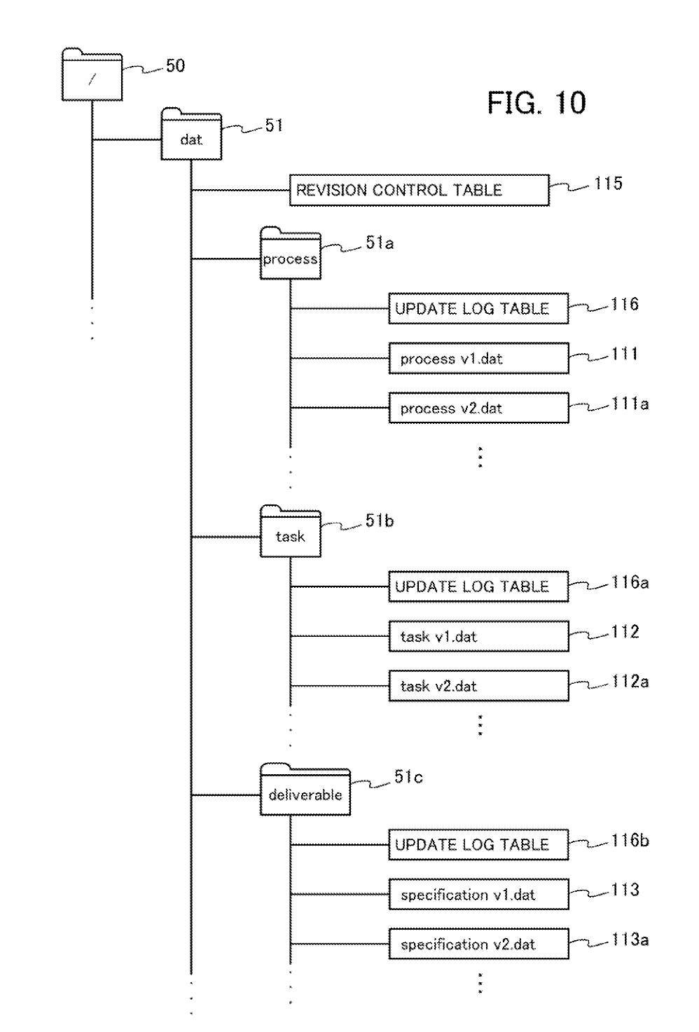

FIG. 10 illustrates an example directory structure of a repository. To manage backup data, the repository 110 has directories 50, 51, 51a, 51b, and 51c having a hierarchical structure illustrated in FIG. 10.

The directory 50 is a root directory. The directory 51 is a subdirectory of the directory 50 and named “dat”. The directories 51a, 51b, and 51c are subdirectories of the directory 51, and named “process”, “task”, and “deliverable”, respectively. In addition, the directory 51 stores the revision control table 115.

The directory 51a stores the process data 111, 111a, . . . and the update log table 116 for the process data. The directory 51b stores the task data 112, 112a, . . . and the update log table 116a for the task data. The directory 51c stores deliverable data 113, 113a, 114, 114a, . . . and the update log table 116b for the deliverable data.

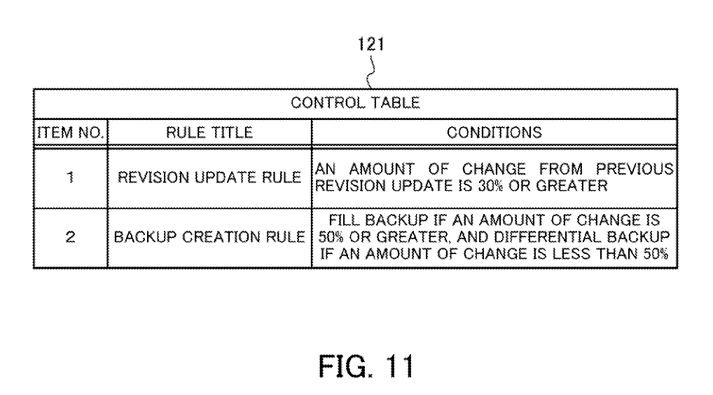

FIG. 11 illustrates an example data structure of a control table. The control table 121 is stored in the control data storage unit 120. The control table 121 has fields for Item No., Rule Title, and Conditions. Information stored in fields arranged in a horizontal direction is associated with each other to form information on one judgment rule.

The Item No. field contains a record number of a judgment rule. The Rule Title field contains the title of a rule to be applied. The Conditions field contains conditions for the rule.

For example, the control table 121 has a record with an item No. of “1”, a rule title of “revision update rule”, and conditions of “an amount of change from previous revision update is 30% or greater”. This is a rule for determining whether to give a new revision number to project information after an update and perform a backup. This rule indicates that a new revision number is given if an amount of change from a previous revision is 30% or greater (in other words, a new revision number is not given if an amount of change is less than 30%).

In addition, assume that the control table 121 has a record with an item number of “2”, a rule title of “backup creation rule”, and conditions of “full backup if an amount of change is 50% or greater and differential backup if an amount of change is less than 50%.” This is a rule for determining which backup to apply, full backup or differential backup, depending on whether an amount of change from a previous revision is 50% or greater, for each kind of data. That is, a full backup is performed if an amount of change is 50% or greater, whereas a differential backup is performed if the amount of change is less than 50%.

The revision update rule is used by the change amount calculation unit 140. For each kind of data, the change amount calculation unit 140 compares data before and after an update, stored in the repository 110, to calculate an amount of change, and makes a determination according to the revision update rule. To calculate an amount of change, the following methods may be employed.

(i) With respect to process data, the number of tasks or a scheduled date may be changed. Therefore, the change amount calculation unit 140 counts, as an amount of change, the number of records that are different between process data before and after an update. For example, a ratio of records (updated or added records) that are different from those of the process data before an update to all records included in the process data after the update may be calculated. Then, according to the judgment rule with the item number of “1”, the change amount calculation unit 140 determines whether the calculated ratio is 30% or greater.

(ii) With respect to task data, task details and task attributes may be added or modified. Therefore, the change amount calculation unit 140 calculates a ratio of items which were changed from the task data before an update to all items (task details, starting date, progress percentage, and ending date) included in the task data. Then, according to the judgment rule with the item number of “1”, the change amount calculation unit 140 determines whether the calculated ratio is 30% or greater.

(iii) With respect to deliverable data, a file including data such as text and drawings may be added or the contents of files may be modified. Therefore, the change amount calculation unit 140 calculates an amount of change in data size from the deliverable data before an update. Alternatively, the change amount calculation unit 140 may analyze the contents of the files before and after an update to calculate an amount of change in the number of letters or lines of text. Then, according to the judgment rule with the item number of “1”, the change amount calculation unit 140 calculates a percentage of the calculated amount to the amount (data size, the number of characters, the number of lines, etc.) of the deliverable data before an update, and determines whether or not the calculated percentage is 30% or greater.

The backup creation rule is used by the data management unit 160. The data management unit 160 makes a determination according to the backup creation rule using an amount of change calculated by the change amount calculation unit 140, for each kind of data. According to the judgment rule with the item number of “2”, the data management unit 160 selects a full backup if the amount of change is 50% or greater, and a differential backup if the amount of change is less than 50%.

In this connection, the judgment rules illustrated in FIG. 11 are just one example, and a project chief leader changes the rules by updating the control table 121. For example, he/she may set a smaller threshold in the revision update rule so as to update a revision number at a shorter time period, thereby making it possible to manage changes to project information in more detail. If he/she sets a larger threshold in the revision update rule, on the other hand, a backup is to be performed at a longer time period, thereby making it possible to save the memory area of the repository 110.

In addition, a different threshold may be set in the revision update rule for each kind of data. For example, such conditions may be set for process data that a backup is to be created irrespective of an amount of change. In addition, the backup creation rule may be so set that a backup method is determined on the basis of an elapsed time or the number of backups. For example, such conditions may be set that a full backup is to be performed irrespective of an amount of change if more than one month passes since the last full backup or if a differential backup is performed five times in a row.

If a plurality of different conditions are set as a rule for the same kind of data, these conditions are implemented by a logical OR operation. For example, assume that three kinds of conditions are set for the backup creation rule: the change amount criterion illustrated in FIG. 11, the elapsed time criterion described above, and the backup count criterion described above. The data management unit 160 is designed to determine that a full backup is to be performed if any one of these conditions is satisfied.

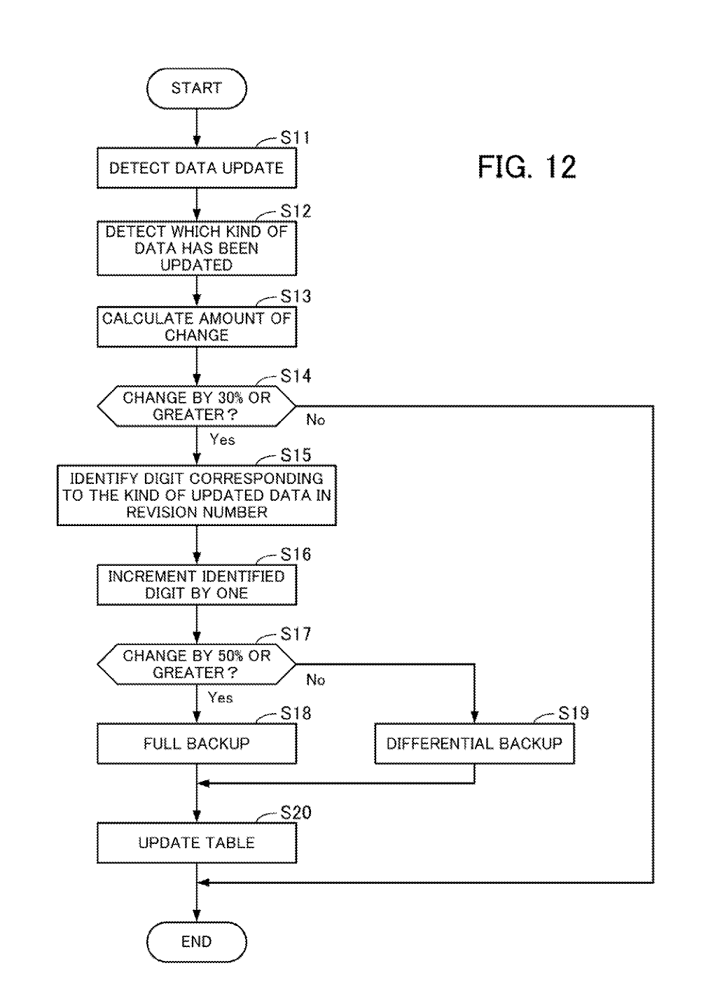

The following describes a backup process to be performed by the project management apparatus 100 with reference to FIG. 12. The flowchart of FIG. 12 will be described step by step.

At step S11, the update unit 130 receives a check-in command from a terminal device 21 to 23. This means that at least one kind of data out of process data, task data, and deliverable date has been updated. The update unit 130 informs the change amount calculation unit 140 of the update of the data. The update unit 130 may also inform the change amount calculation unit 140 which kind of data has been updated.

At step S12, the change amount calculation unit 140 recognizes the kind of updated data. That is, it is determined which data has been updated, process data, task data, or deliverable data. In this connection, a plurality of data may have been updated simultaneously.

At step S13, the change amount calculation unit 140 acquires the updated data and data of previous revision (backup data) with respect to the kind of data recognized at step S12, from the repository 110. Then, the change amount calculation unit 140 calculates an amount of change of the data from the previous revision. The methods described with reference to FIG. 11 may be employed to calculate the amount of change. For example, with respect to deliverable data, an amount of increase (or decrease) in data size of a file or an amount of increase (or decrease) in the number of characters or letters in the file may be calculated.

At step S14, the change amount calculation unit 140 consults the control table 121 stored in the control data storage unit 120 to confirm the revision update rule. The change amount calculation unit 140 then determines whether the conditions defined in the revision update rule are satisfied or not. For example, it is determined whether an amount of change calculated at step S13 is 30% or greater. If such a condition is satisfied, the process proceeds to step S15. Otherwise, the process is terminated. If plural kinds of data have been updated, the change amount calculation unit 140 makes a determination for each kind of data, and if it is confirmed that at least one kind of data satisfies the conditions, the process proceeds to step S15.

At step S15, the revision control unit 150 acquires the latest revision number from the revision control table 115 stored in the repository 110. Then, the revision control unit 150 identifies a digit corresponding to the kind of data which is determined to satisfy the conditions at step S14, out of the plurality of digits included in the revision number. That is to say, the revision control unit 150 identifies the first digit for process data, the second digit for task data, and the third digit for deliverable data.

At step S16, the revision control unit 150 increments the value of the digit identified at step S15 (by one) to generate a new revision number. Then, the revision control unit 150 informs the data management unit 160 of the generated revision number. If there are plural kinds of data which are determined to satisfy the conditions at step S14, the values of corresponding digits are incremented. For example, if an amount of change in task data and that in deliverable data are both 30% or greater, the values of the second and third digits of the latest revision number are incremented.

At step S17, the data management unit 160 consults the control table 121 to confirm the backup creation rule. The data management unit 160 then determines whether the conditions defined in the backup creation rule are satisfied or not. For example, it is determined whether the amount of change calculated at step S13 is 50% or greater. If such a condition is satisfied (full backup is determined to be performed), the process proceeds to step S18. Otherwise (differential backup is determined to be performed), the process proceeds to step S19. If there are plural kinds of data to be backed up, such a determination is made for each kind of data.

At step S18, the data management unit 160 performs a full backup of the kind of data which is determined to satisfy the conditions at step S17. Then, the process proceeds to step S20. In this connection, the full backup is performed in the aforementioned manner.

At step S19, the data management unit 160 performs a differential backup of the kind of data which is determined not to satisfy the conditions at step S17. Then, the process proceeds to step S20. In this connection, this differential backup is performed in the manner described earlier.

At step S20, the data management unit 160 updates the update log table corresponding to the kind of data backed up, out of the update log tables 116, 116a, and 116b. In addition, the revision number supplied from the revision control unit 150 is set in the revision control table 115 together with the parent number (previous revision number) and the storing date and time.

As described above, when an amount of data change satisfies the first conditions, the revision control unit 150 updates a revision number. The data management unit 160 performs a full or differential backup of updated data depending on whether the amount of data change satisfies the second conditions. The data management unit 160 also records the new revision number in the repository 110 in association with the backup data.

The following describes a backup data retrieval process which is performed by the project management apparatus 100. The retrieval unit 170 consults the update log tables 116, 116a, and 116b to retrieve project information (including process data, task data, and deliverable data) corresponding to a revision number.

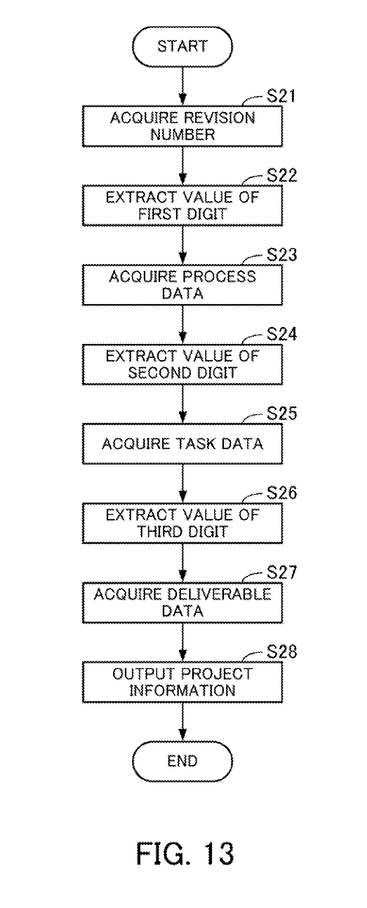

FIG. 13 is a flowchart of a backup data retrieval process. This process will be described step by step.

At step S21, the retrieval unit 170 receives a checkout command from the terminal device 21 to 23. The checkout command includes a revision number indicating a desired revision. As an example, assume that a revision number of “1.5.2” is specified.

At step S22, the retrieval unit 170 extracts the value of the first digit from the revision number received at step S21. In the case of the revision number of “1.5.2”, the value of “1” is extracted.

At step S23, the retrieval unit 170 consults the update log table 116 regarding the process data to search for a record with a revision ID corresponding to the value extracted at step S22. Then, the retrieval unit 170 retrieves data of a file name indicated by the found record from the repository 110. In the case of the revision number of “1.5.2”, a record with revision ID of “v1” is found, and “process v1.dat” is retrieved from the repository 110.

If the acquired data is differential backup data, the retrieval unit 170 traces and retrieves data up to the first-retrieved full backup data to restore process data of the desired revision on the basis of the retrieved full and differential backup data.

At step S24, the retrieval unit 170 extracts the value of the second digit from the revision number acquired at step S21. In the case of the revision number of “1.5.2”, “5” is extracted.

At step S25, the retrieval unit 170 consults the update log table 116a regarding the task data to search for a record with a revision ID corresponding to the value extracted at step S24. Then, the retrieval unit 170 retrieves data with a file name indicated by the found record from the repository 110. In the case of the revision number of “1.5.2”, the record with the revision ID of “v5” is found, and “task v5.dat” is retrieved from the repository 110.

If the retrieved data is differential backup data, the retrieval unit 170 restores task data of desired revision in the same manner as process data. For example, if “task v5.dat” is differential backup data, the retrieval unit 170 further retrieves full backup data, “task v3.dat”, and differential backup data, task v4.dat”, from the repository 110. Then, the task data is restored from these data, “task v3.dat”, “task v4.dat”, and “task v5.dat”. At step S26, the retrieval unit 170 extracts the value of the third digit from the revision number acquired at step S21. In the case of the revision number of “1.5.2”, “2” is extracted.

At step S27, the retrieval unit 170 consults the update log table 116b regarding the deliverable data to search for a record with revision ID corresponding to the value extracted at step S26. The retrieval unit 170 then retrieves data with a file name indicated by the found record from the repository 110. In the case of the revision number of “1.5.2”, a record with revision ID of “v2” is found, and “specification v2.dat” is retrieved from the repository 110.

In this connection, if the retrieved data is differential backup data, the retrieval unit 170 restores deliverable data of desired revision, in the same way as the other kinds of data. For example, if “specification v2.dat” is differential backup data, the retrieval unit 170 further retrieves full backup data “specification v1.dat” from the repository 110, and restores deliverable data from these “specification v1.dat” and “specification v2.dat”. If a differential backup of deliverable data is made on a file basis, the deliverable data may be restored by replacing the “specification v1.dat” with “specification v2.dat”.

At step S28, the retrieval unit 170 collectively sends the process data acquired at step S23, the task data acquired at step S25, and the deliverable data acquired at step S27 as project information. The project information may be sent directly to the terminal device 21 to 23. Alternatively, the display processor 180 is designed to create an operation screen which has a link to connect to the project information, so that the user is able to download the information. Yet alternatively, a display screen which displays partial contents of the project information may be provided by the display processor 180 to the terminal device 21 to 23.

As described above, the retrieval unit 170 receives a command including a revision number, and retrieves project information including three kinds of data from the repository 110 on the basis of the values of three digits included in the revision number. The retrieved project information is project information of revision indicated by the revision number (that is, past project information). For example, the user performs the checkout operation while viewing a revision number selection screen displayed on the monitor of the terminal device 21 to 23.

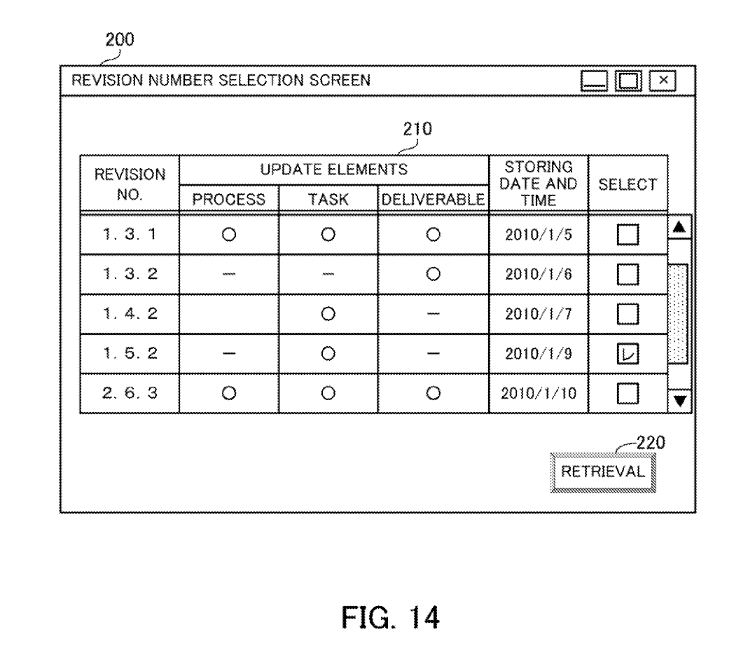

FIG. 14 is an example revision number selection screen. The revision number selection screen 200 is an operation screen that is provided by the display processor 180, and displayed on the monitor of the terminal device 21 to 23. The display processor 180 creates a revision number selection screen 200 on the basis of the revision control table 115 stored in the repository 110. The revision number selection screen 200 includes a revision information display area 210 and a retrieval button 220.

The revision information display area 210 is a display area for displaying a revision number of project information and information on a revision indicated by the revision number in association with each other. More specifically, a list of the update status of data of each revision (which kinds of data were updated) and the storing date and time of backup data of the revision are displayed. Referring to FIG. 14, data with a circle indicates that the data was updated from a previous revision, and data with a hyphen indicates that the data was not updated from a previous revision.

In addition, the revision information display area 210 has a checkbox for selection of a revision number. The user checks or checks off this checkbox by using an input device. A checkbox of on (checkbox checked) means that a corresponding revision number is selected. FIG. 14 depicts the case where a revision number of “1.5.2” is selected.

The retrieval button 220 is a button for retrieving project information corresponding to a revision number selected on the revision information display area 210, from the project management apparatus 100. By the user pressing the retrieval button 220, the terminal device to 23 sends the project management apparatus 100 a checkout command including the revision number selected on the revision information display area 210. The retrieval unit 170 of the project management apparatus 100 receives the checkout command, and retrieves project information corresponding to the selected revision number from the repository 110 with the method illustrated in FIG. 13.

As described above, the project management apparatus 100 manages the update statuses of plural kinds of data by using revision numbers. A revision number has three digits corresponding to three kinds of data. Therefore, by comparing revision numbers before and after an update with each other, it is possible to identify which kinds of data were updated.

Accordingly, it is possible to easily confirm the update status of each kind of data by confirming a change in each digit of a revision number on the revision number selection screen 200. In addition, it is also possible to confirm plural kinds of past data included in the project information. As a result, it is possible to entirely review desired past project information.

Further, it is possible to automatically select a backup method (full backup or differential backup) depending on an amount of data change. Thus, it is possible to save a storage area for storing backup data, as compared with the case of always carrying out a full backup. In addition, it is possible to suppress processing loads of restoring project information of desired revision, as compared with the method of always carrying out differential backup after a full backup is first performed.

The disclosed update management apparatus, update management method, and update management program make it possible to simplify revision control of a data set including plural kinds of data.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that various changes, substitutions, and alterations could be made hereto without departing from the spirit and scope of the invention.

What is claimed is:

1. An update management apparatus for managing updates of a data set including plural kinds of data, comprising:
a detection unit that detects an update of one or more kinds of data of the data set stored in a storage unit; and
a management unit that generates a symbol sequence including a plurality of symbols corresponding to the respective plural kinds of data, according to a detection result, and stores the generated symbol sequence in the storage unit as information indicating a version of the data set,
wherein the management unit modifies a symbol sequence indicating a previous version to change symbols corresponding to kinds of data whose updates have been detected, out of the plurality of symbols, to generate the symbol sequence indicating an updated version.

2. The update management apparatus according to claim 1, wherein the management unit uses, in the generated symbol sequence, symbols corresponding to kinds of data whose updates have not been detected, out of the plurality of symbols included in the symbol sequence.

3. The update management apparatus according to claim 1, wherein the management unit generates a copy of at least part of data included in the data set, and stores the copy in the storage unit in association with the symbol sequence indicating the updated version.

4. The update management apparatus according to claim 1, wherein:
a history of updates of the plural kinds of data is managed for each kind of data in the storage unit; and
the update management apparatus further comprises a retrieval unit that retrieves, upon receipt of a symbol sequence indicating a version of the data set, kinds of data corresponding to respective symbols of the received symbol sequence from the storage unit.

5. An update management method to be executed by a computer for managing updates of a data set including plural kinds of data, the method comprising:
detecting an update of one or more kinds of data of the data set stored in a storage unit; and
generating a symbol sequence including a plurality of symbols corresponding to the respective plural kinds of data, according to a detection result, and storing the generated symbol sequence in the storage unit as information indicating a version of the data set,
wherein, to generate the symbol sequence indicating an updated version, a symbol sequence indicating a previous version is modified to change symbols corresponding to kinds of data whose updates have been detected, out of the plurality of symbols.

6. A non-transitory computer-readable medium storing an update management program for managing updates of a data set including plural kinds of data, the program causing a computer to execute:
detecting an update of one or more kinds of data of the data set stored in a storage unit; and
generating a symbol sequence including a plurality of symbols corresponding to the respective plural kinds of data, according to a detection result, and storing the generated symbol sequence in the storage unit as information indicating a version of the data set,
wherein, to generate the symbol sequence indicating an updated version, a symbol sequence indicating a previous version is modified to change symbols corresponding to kinds of data whose updates have been detected, out of the plurality of symbols.
